(19) United States
(12) Patent Application Publication
(10) Pub. No.: US 2002/0164993 A1
(43) Pub. Date: Nov. 7, 2002

(54) Method and system for locating and tracking a mobile device

(76) Inventor: Nicolas F. Elliot, Lynnfield, MA (US)

Correspondence Address: STAAS & HALSEY LLP, 700 11TH STREET, NW, SUITE 500, WASHINGTON, DC, 20001, US

(21) Appl. No.: 09/734,033

(22) Filed: Dec. 12, 2000

(51) Int. Cl. H04Q 7/20

(52) U.S. Cl. 455/456; 455/457; 455/432

(57) ABSTRACT

The present invention is a system in which a location of a mobile device can be monitored to ensure that the mobile device is traveling on a predetermined path and has not traveled outside of a predetermined geographical region. If the mobile device deviates from the predetermined path, a monitoring device can alert the mobile device and relay a new optimal path to reach the desired destination. If the mobile device approaches or travels outside of a specified geographical region, both the mobile device and a third party can be alerted.

### BACKGROUND OF THE INVENTION

1. Field of the Invention

The present invention is directed to a system which can identify geographic/cartographic locations of mobile device to track a location of the mobile device, alert a user of the mobile device of this location or to alert a third party of this location.

2. Description of the Related Art

The increased availability and use of mobile devices such as cellular telephones and personal digital assistants has brought a demand to track such mobile devices for purposes such as providing directions to a user of such mobile devices and tracking a geographic or cartographic location of a mobile device worn by a parolee or person under similar geographic limitations. However, traditionally tracking mobile devices, such as for the purpose of monitoring a parolee, required a third party monitor to actually place a call to the parolee, receive a call from the parolee or physically check a location of the parolee. Similarly, to monitor a path taken by a user of a cellular phone, for example, to make sure that a path which is intended to be followed is actually followed by that individual, it was necessary to speak directly with the individual to obtain their location and determine whether the individual has deviated from the intended path.

What is needed is a system that will overcome the above-described problems and provide automatic notification and monitoring of a location of a mobile device.

### SUMMARY OF THE INVENTION

It is an object of the present invention to provide a system to determine a location of a mobile device and to compare the determined location to a stored path plan to notify the mobile device of any deviation from the stored path plan.

It is also an object of the present invention to determine a location of a mobile device and to compare the determined location to a specific location boundary and to transmit an alert signal to a third party if the mobile device is outside of the specific location boundary.

It is also an object of the present invention to match a voice pattern transmitted from a mobile device to a monitoring device with a stored individual-specific voice pattern and to alert a third party receiver if the transmitted voice pattern does not match the stored individual-specific voice pattern.

It is also an object of the present invention to match an identifier embedded in a signal transmitted from a mobile device with a stored individual-specific identifier and to alert a third party if the transmitted identifier does not match the stored individual-specific identifier.

These together with other objects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is an overall diagram of the system of an embodiment of the present invention.

FIG. 2 is a flow chart of a process according to an embodiment of the present invention.

FIG. 3 is a flow chart of a process according to an embodiment of the present invention.

FIG. 4 is a flow chart of a process according to an embodiment of the present invention.

### DESCRIPTION OF THE PREFERRED EMBODIMENTS

The present invention is concerned with providing optional real-time monitoring of a route taken by a mobile device to ensure that it is consistent with directions given or a previously determined path plan. In addition, according to another embodiment of the present invention, monitoring the path taken may be performed with or without maintaining an open voice circuit between the mobile device and a mobile network. In addition, the monitored party may be provided with an alert if path described in previous example is being deviated from. In addition, the mobile device may instruct the system of the present invention to store one or more locations over time for later recall. These locations can also be time-stamped providing additional tracking information.

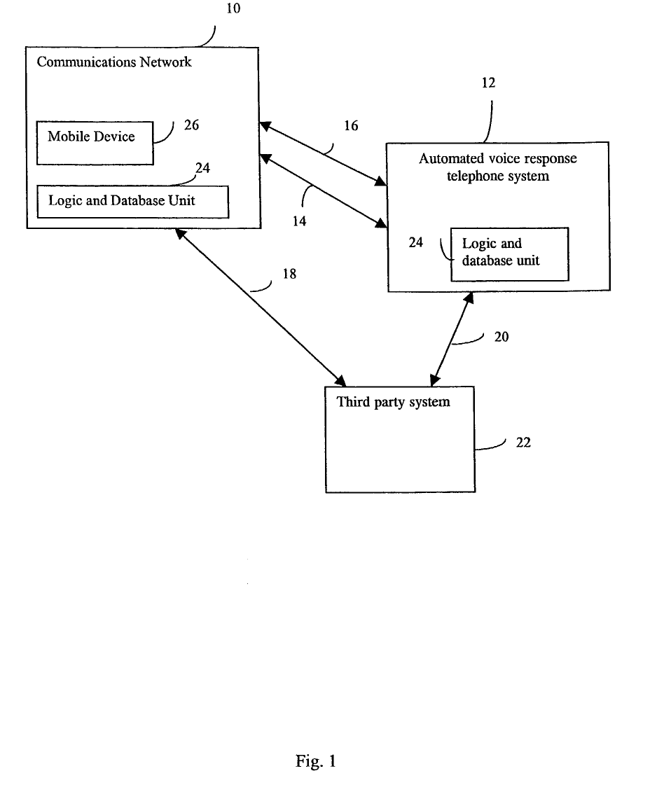

Referring to FIG. 1, communication network 10, which includes the mobile device, may include a telephone network, mobile network and land based networks, including mobile telephone or personal two-way wireless equipment (e.g. voice pager, “walkie-talkie”) including location finding equipment for those devices. A variety of such location finding equipment already exists, many are being made available to comply with the FCC E911 Phase II mandate required in year 2001. The location finding technology and equipment is currently known and available. Most significant technologies for locating such mobile equipment are GPS, DGPS, AOA, TOA and TDOA. These provide sufficient data to determine geographical coordinates (and sometimes altitude) that can be used to accurately determine the cartographic location of a communication device. Products using these technologies and services can be found at or purchased from companies such as SigmaOne, Cell-Loc Inc. Cambridge Positioning Systems, AccuCom Wireless Services Inc, TruePosition, ArrayCom, E-Systems, Hazeltine, KSI Inc. Lockheed Sanders, SnapTrack, US Wireless.

Automated voice response telephone system 12 could be an AccessNP/AccessMAX system, an Infinity3 System or other type system. These systems can be obtained from Comverse Network Systems, Inc.

Automated voice response telephone system 12, which includes the monitoring device, preferably supports both voice and data connections and provides user I/O, and could provide much (or all) of the analysis, data look-up and computational effort of the present invention.

Automated voice response telephone system 12 can accept location based data from the communication network 10 or intermediate equipment and coordinate it with an incoming or outgoing telephone circuit (e.g. T1 channel) call if the service subscriber is requiring voice interaction (as opposed to monitoring), it will provide the end user feedback via voice (using computer generated speech [e.g. computer generated Text-To-Speech] or pre-recorded voice sound segments), fax or digital data to the mobile device 26.

Automated voice response telephone system 12 is also capable of outdialing to a telephone or other communication device known in the art to instruct, query, or notify the device user as needed. Automated voice response telephone system 12 can accept location identifying information such as pre-determined addresses or coordinates if logic and databases for determining a location of the mobile device 26 are not located within the automated voice response telephone system 12. Alternatively, if the logic and databases are located within the automated voice response telephone system 12, it can calculate the coordinates, and address of the mobile device 26. Location and path data generated in the automated voice response telephone system 12 would be used for providing automatically generated voice instructions (e.g. via TTS or pre-recorded voice segments), or generate faxes or digital instructions.

Link 14 is preferably a data link such as an Ethernet, serial data link, circuit switched connections for call-associated or handset-associated data, for example, including any interface capable of passing data such as geographical coordinates, elevation, or more primitive data for determining geographic position such as cell and sector, radius, starting angle and real coverage angle.

Data Link 16 is preferably a speech/fax/modem capable interface (e.g. T1 telephone lines, Ethernet for VoIP, or graphic data). Data link 14 is can supply automated interaction with an end user. Data Link 16 can also be used in place of Link 14, discussed above, for supplying call or handset associated data (e.g. via DTMF or other signaling of call associated data).

Data link 18 is preferably a data link such as an Ethernet, a serial data link or a circuit switched connection for call-associated or handset-associated data.

Data links 14 and 16 may be used in conjunction with each other or separately for data and voice communication therebetween.

Third party system 22 is optional and may include the police or other party which would receive and/or transmit information to/from the automated voice response telephone system 12. For example, if it is determined that the mobile device 26 has gone outside of its specified geographic boundary, or entered a specific boundary, third party system 22 would be notified by the automated voice response telephone system 12 and may take appropriate action.

Logic and database unit 24 may optionally be provided within either automated voice response telephone system 12 or communication network 10. The logic and database unit 24 preferably determines geographical coordinates and/or physical addresses of calling and/or called parties, i.e., mobile device 26, based on telephone network addresses and/or mobile transmitter location finding information. Path calculation can be optionally provided within logic and database unit 24 as well. Location and path data generated here would be used by automated voice response telephone system 12 to provide automatically generated voice instructions (e.g. via TTS or pre-recorded voice segments), or generate faxes or digital instructions.

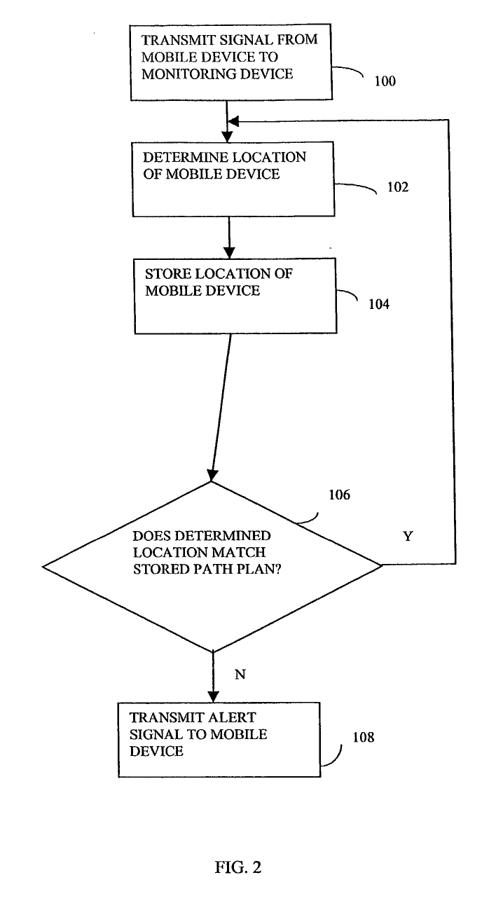

Referring to FIG. 2, in operation 100, a signal is transmitted from the mobile device 26 to a monitoring device. This may be accomplished either by the monitoring device periodically contacting the mobile device 26 to receive the signal or by the mobile device 26 periodically transmitting a signal to the mobile device 26. This period could be modified based on the area or zone in which the mobile device is located.

From operation 100 the process moves to operation 102, where the monitoring device determines the location of the mobile device 26. This may be done according any of the above-described methods which are known in the art.

Once the location of the mobile device 26 has been determined, optionally the location of the device is stored in a database, such as logic and database unit 24 in operation 104. In operation 106, it is determined whether the location of the mobile device 26 matches a previously stored path plan. If the location of the mobile device 26 does not match the stored path plan, an alert signal is transmitted to the mobile device 26 in operation 108 the alert signal may include a voice message, such as “you have deviated from your path plan”. Optionally, directions, or a new optimal path, to an ultimate destination may be recalculated based on the present location of the mobile device 26 and such directions may be transmitted, via a computer generated voice operator, for example, to the mobile device 26.

If the location of the mobile device 26 matches the path plan, the process moves to operation 102 where the location of the mobile device 26 is determined again. Thus, according to the present invention, the location of the mobile device 26 may be sampled at a predetermined time interval to ensure that the user of the mobile device 26 is following the prescribed path plan.

Optionally, the location of the mobile device 26 determined in operation 102 may be compared to a user-specific location boundary to determine if the mobile device 26 has traveled to a restricted location or out of a specific geographical region.

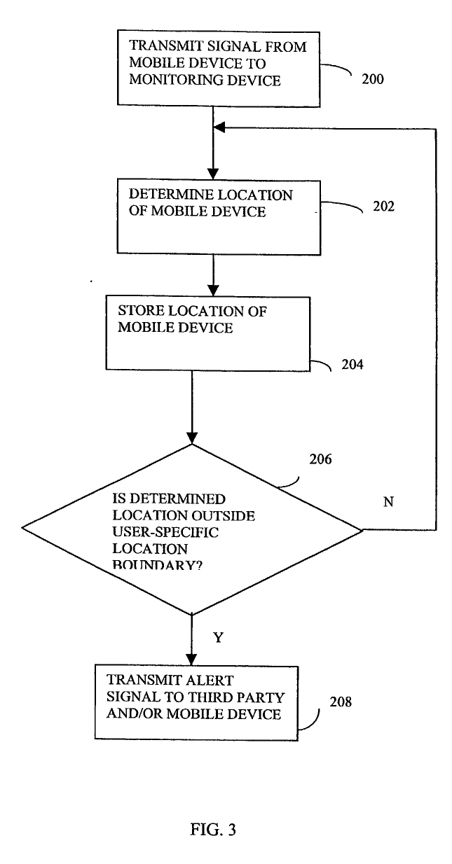

Referring to FIG. 3, in operation 200 a signal is transmitted from the mobile device 26 to the monitoring device. From this signal, the monitoring device determines a location of the mobile device 26 in operation 202. As described with respect to FIG. 2, alternatively the monitoring device may transmit a signal to the mobile device 26 to determine the location of the mobile device 26.

From operation 202, the process moves to operation 204, where the location of the mobile device 26 is stored. This operation is optional. In operation 206, it is determined whether the location of the mobile device 26 is outside of a user-specific location boundary. For example, a mobile device attached to a parolee may contact the monitoring device, or vice versa, at a specific time to transmit a signal from which the location of the mobile device 26 can be determined. Thereby, the location of a parolee or the like can constantly be monitored to ensure compliance with their parole terms. Of course, the present invention is not limited to use with parolees.

If the location of the mobile device 26 is outside of the user-specific boundary location, an alert signal is transmitted in operation 208 to a third party, such as the police, and/or to the mobile device 26 itself. If the location of the mobile device 26 is not outside of the user-specific boundary, the process moves to operation 202, where the location of the mobile device 26 is again determined. Preferably, the location of the mobile device 26 is determined according to a predetermined time interval which can approximate constant monitoring.

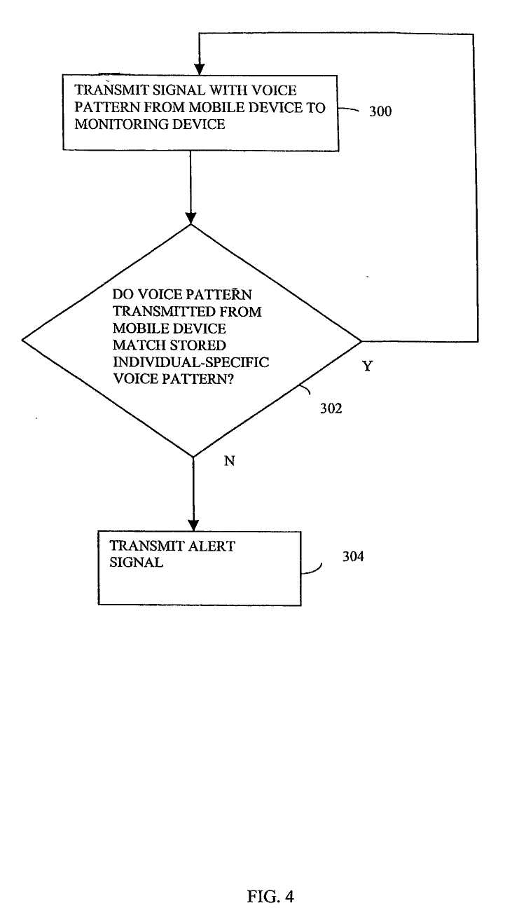

Referring to FIG. 4, operation 300 is similar to operations 100 and 200, where a signal is transmitted from the mobile device 26 to the monitoring device. According to this embodiment, the signal may contain a voice message, such as a spoken phrase including at least one word. This phrase is then compared, in operation 302, to a individual-specific voice pattern, which has been previously stored. According to this embodiment, further assurance can be obtained that the parolee, for example, is actually the individual carrying the mobile device 26. Again, in operation 300, the monitoring device may contact the mobile device at a predetermined time or interval.

If the voice pattern transmitted from the mobile device 26 to the monitoring device does not match the store voice pattern, the process moves to operation 304 where an alert signal, which may include a voice or text message, is transmitted to the third party. In addition, this alert signal may be transmitted to the mobile device 26. If the voice pattern matches the stored voice pattern, the process moves to operation 300, where the process begins again at a new time determined according to a desired time interval.

In addition, according to the present invention, a random dynamically generated set of words/phrases may be spoken back to a party using the mobile device 26 to assure there are no fraudulent attempts at impersonation of the mobile device carrier.

Still further, the boundary may change over time. For example, during a commute of some sort, the mobile device 26 may be in an area for only a short period of time, or be permitted or required to be in specified areas at specified times , e.g. must be at work every weekday between 9 a.m. and 5 p.m.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method of monitoring a mobile device comprising:
automatically transmitting a signal from the mobile device to a monitoring device at predetermined time intervals;
determining a location based on each transmitted signal received by the monitoring device;
comparing each location of the mobile device to a stored path plan; and
automatically transmitting an alert signal from the monitoring device to the mobile device if one of the locations does not match the path plan.

2. The method as claimed in claim 1, wherein the alert signal includes a voice message.

3. The method as claimed in claim 2, wherein the voice message includes a new optimal path to reach a desired destination.

4. The method as claimed in claim 1, further comprising automatically storing the locations of the mobile device at the predetermined time intervals.

5. The method as claimed in claim 1, wherein a user of the mobile device initiates the transmission of the signal from the mobile device.

6. The method as claimed in claim 4, wherein the stored locations can be retrieved by a user of the mobile device.

7. The method as claimed in claim 1, further comprising:
comparing each cartographic location with a user-specific location boundary; and
transmitting an alert signal to a third-party receiver if one of the cartographic locations is outside the user-specific location boundary.

8. A method of monitoring a location of an individual equipped with a mobile device, comprising:
automatically transmitting a signal corresponding to a geographical location from the mobile device to a monitoring device; and
comparing the geographic location to a user-specific location boundary.

9. The method as claimed in claim 8, further comprising alerting a third-party receiver if the geographic location does not match the user-specific location boundary.

10. The method as claimed in claim 8, further comprising:
matching a voice pattern transmitted from the mobile device to the monitoring device with a stored individual-specific voice pattern
alerting a third-party receiver if the transmitted voice pattern does not match the stored individual-specific voice.

11. The method as claimed in claim 10, further comprising prompting a user of the mobile device to speak a phrase including at least one word.

12. The method as claimed in claim 11, further comprising comparing at least one word with the stored individual-specific voice pattern, wherein the stored individual-specific voice pattern is the phrase including the at least one word.

13. The method as claimed in claim 1, wherein the monitoring device automatically contacts the mobile device at a predetermined time to determine a location of the mobile device.

14. The method as claimed in claim 10, further comprising automatically calling, at a predetermined time, the mobile device.

15. The method as claimed in claim 8, further comprising:
matching an identifier embedded in the transmitted signal with a stored individual-specific identifier; and
alerting a third-party receiver if the transmitted identifier does not match the stored individual-specific identifier.

16. The method as claimed in claim 8, further comprising sending an alert signal to the mobile device if the geographic location of the mobile device is within a predetermined geographical boundary.

17. The method as claimed in claim 8, further comprising sending an alert signal to the mobile device if the geographic location of the mobile device is outside of a predetermined geographical boundary.

18. The method as claimed in claim 16, wherein the alert signal includes an electronic mail message.

19. The method as claimed in claim 16, wherein the alert signal includes a voice message.

20. A system for monitoring a mobile device comprising:
means for automatically transmitting a signal from the mobile device to a monitoring device at predetermined time intervals;
means for determining a location based on each transmitted signal received by the monitoring device;
means for comparing each location of the mobile device to a stored path plan; and
means for automatically transmitting an alert signal from the monitoring device to the mobile device if one of the locations does not match the path plan.

21. A system for monitoring a location of an individual equipped with a mobile device, comprising:
means for automatically transmitting a signal corresponding to a geographical location from the mobile device to a monitoring device; and
means for comparing the geographic location to a user-specific location boundary.
